(19) United States
(12) Patent Application Publication
(10) Pub. No.: US 2009/0313205 A1
(43) Pub. Date: Dec. 17, 2009

(54) TABLE STRUCTURE ANALYZING APPARATUS, TABLE STRUCTURE ANALYZING METHOD, AND TABLE STRUCTURE ANALYZING PROGRAM

(75) Inventors: Takanori HINO, Tokushima-shi (JP); Shingo Ochi, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JustSystems Corporation, Tokushima-shi (JP)

(21) Appl. No.: 12/477,670

(22) Filed: Jun. 3, 2009

(30) Foreign Application Priority Data
Jun. 3, 2008 (JP) 2008-146159

(51) Int. Cl. G06N 5/02

(52) U.S. Cl. 706/54

(57) ABSTRACT

A table structure analyzing apparatus extracts first row data and second row data in table data. Similarity between the data is computed based on Levenshtein distance or the number of characters. Further, similarity between the first row and the second row as a whole is determined. When the similarity is equal or less than a predetermined threshold value, it is determined that the boundary between the first and second rows is the boundary between a header part and a substantive part. A similar determination is made in the direction of columns.

### BACKGROUND OF THE INVENTION

1. Field of the Invention

The present invention relates to a technology of processing documents and, more particularly, to a technology of analyzing the structure of table data.

2. Description of the Related Art

“Table data” is a format for storing data that is easy not only for people but also for computers to process information. Table data usually includes a header part and a substantive part. A header part is an area where data indicating the headers of a table (hereinafter, referred to as header data) is located. A substantive part is an area where data indicating the substantive content of the table (hereinafter, referred to as “substantive data”) is located.

[patent document No. 1] JP 2001-134605

In order to process table data properly, it is necessary to identify an header part and a substantive part, i.e., header data and substantive data. The header part and the substantive part may be manually identified explicitly before processing the table data. Such an approach would, however, be complicated. Alternatively, meta information for identifying the header part and the substantive part may be set up in the table data. It would not be practical to force all table creators to set up meta information.

### SUMMARY OF THE INVENTION

The present invention addresses the problem and a purpose thereof is to provide a technology of efficiently identifying a header part and a substantive part in table data.

One embodiment of the present invention relates to a table structure analyzing apparatus. The apparatus extracts data from the first data series and the second data series in table data. A “data series” may be a “row” or a “column” of table data. If the data are found to be dissimilar, it is determined that the boundary between the first data series and the second data series represents the boundary between the header part and the substantive part of the table data.

Similarity is computed according to the number of steps required to produce the second data by processing the first data.

Optional combinations of the aforementioned constituting elements, and implementations of the invention in the form of systems, programs, and recording mediums may also be practiced as additional modes of the present invention.

### BRIEF DESCRIPTION OF THE DRAWINGS

FIG. 1A shows table data before identifying a header part and a substantive part;

FIG. 1B shows the table data of FIG. 1A after the header part and the substantive part are identified;

FIG. 2 is a functional block diagram of a table structure analyzing apparatus;

FIG. 3 shows exemplary table data where some of the cells are merged;

FIG. 4 shows another exemplary table data where some of the cells are merged;

FIG. 5 is a flowchart of steps for determining a boundary;

FIG. 6 shows an XML document based on the table data of FIG. 1A;

FIG. 7 shows table data where only the first row forms a header part;

FIG. 8 shows an XML document based on the table data of FIG. 7;

FIG. 9 shows table data where only the first column forms a header part;

FIG. 10 shows an XML document based on the table data of FIG. 9;

FIG. 11 shows table data where the first and second columns form a header part;

FIG. 12 shows an XML document based on the table data of FIG. 11;

FIG. 13 shows table data where the first and second rows form a header part;

FIG. 14 shows an XML document based on the table data of FIG. 13;

FIG. 15 is a functional block diagram of the table structure analyzing apparatus according to the second embodiment;

FIG. 16 shows an example of a screen displaying the table data shown in FIG. 1A in the spread sheet format;

FIG. 17 shows an example of a user interface screen for acknowledging information related to the table structure from the user;

FIG. 18 shows an example of a screen displaying the table data shown in FIG. 1A in the spread sheet format;

FIG. 19 shows an example of a user interface screen for acknowledging information related to the table structure from the user;

FIG. 20 shows another example of a screen displaying the table data shown in FIG. 1A in the spread sheet format;

FIG. 21 shows an example of a user interface screen for acknowledging information related to the table structure from the user; and

FIG. 22 shows an example of a screen displaying the table data shown in FIG. 1A in the spread sheet format.

### DETAILED DESCRIPTION OF THE INVENTION

The invention will now be described by reference to the preferred embodiments. This does not intend to limit the scope of the present invention, but to exemplify the invention. In the following description, some of the entries in tables are assumed to be full-width Japanese characters but translated in meaning into English for ease of understanding.

### First Embodiment

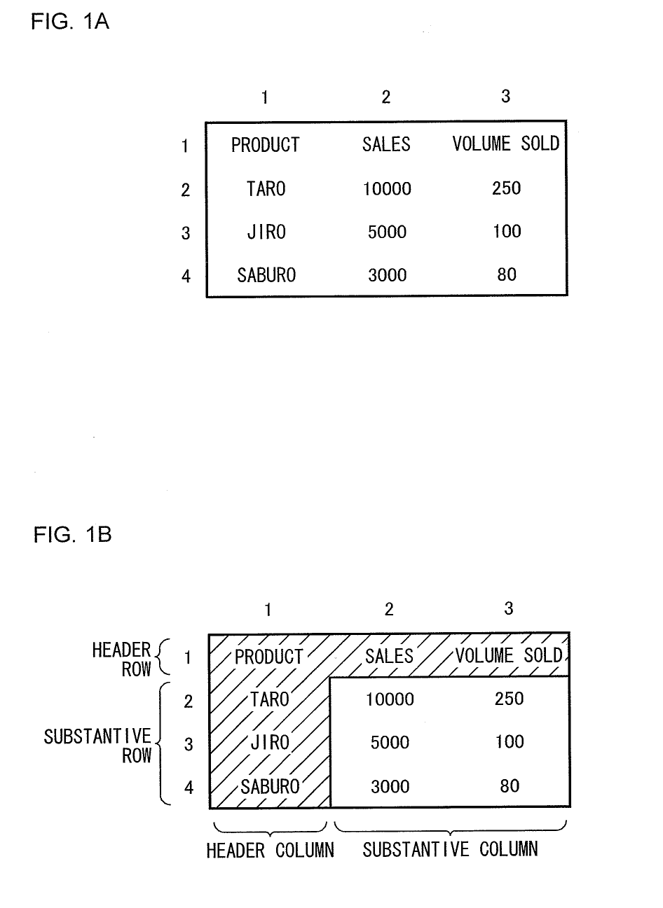

FIG. 1A shows exemplary table data before identifying a header part and a substantive part.

The table data shown in FIG. 1A include a total of 12 data items organized as 4 rows×3 columns. The data in the first row and the second column (hereinafter, denoted by “data (1*2)”), i.e., “Sales”, represents the header name of the second column, i.e., the “column header”. Similarly, the entry “Volume sold (1*3)” represents the column header of the third column. “Taro (2*1)” represents the header name of the second row, i.e., the “row header”.

Accordingly, the data “10000” in the second row and the second column indicates that the “Sales (1*2)” of the “Product (1*1)” named “Taro (2*1)” is “10000”. Hereinafter, a series of data represented as a row or a column will be referred to as “data series”.

FIG. 1B shows the table data of FIG. 1A after the header part and the substantive part are identified.

“Product”, “Sales”, and “Volume sold” in the first row are all header data representing column headers. Hereinafter, a row like the first row that includes only header data will be referred to as “header row”. “Taro” in the second row is header data representing a row header, while “10000” and “250” are substantive data. A row like the second row that includes substantive data will be referred to as “substantive row”. The third and fourth rows are also substantive rows.

“Product”, “Taro”, “Jiro”, and “Saburo” in the first column are all header data representing row headers. Hereinafter, a column like the first column that includes only header data will be referred to as “header column”. “Sales” in the second column is data representing a column header, and “10000”, “5000”, and “3000” are substantive data. A column like the second column that includes substantive data will be referred to as “substantive column”. The third column is also a substantive column.

The header row and the header column form a “header part”, and the other parts form a “substantive part”. In FIG. 1B, the header part is indicated by diagonal lines. The same notation is used in the following drawings, too.

A table structure analyzing apparatus 100 according to the embodiment is an apparatus that acquires table data comprising rows and columns as shown in FIG. 1A and automatically identifies a header part and a substantive part.

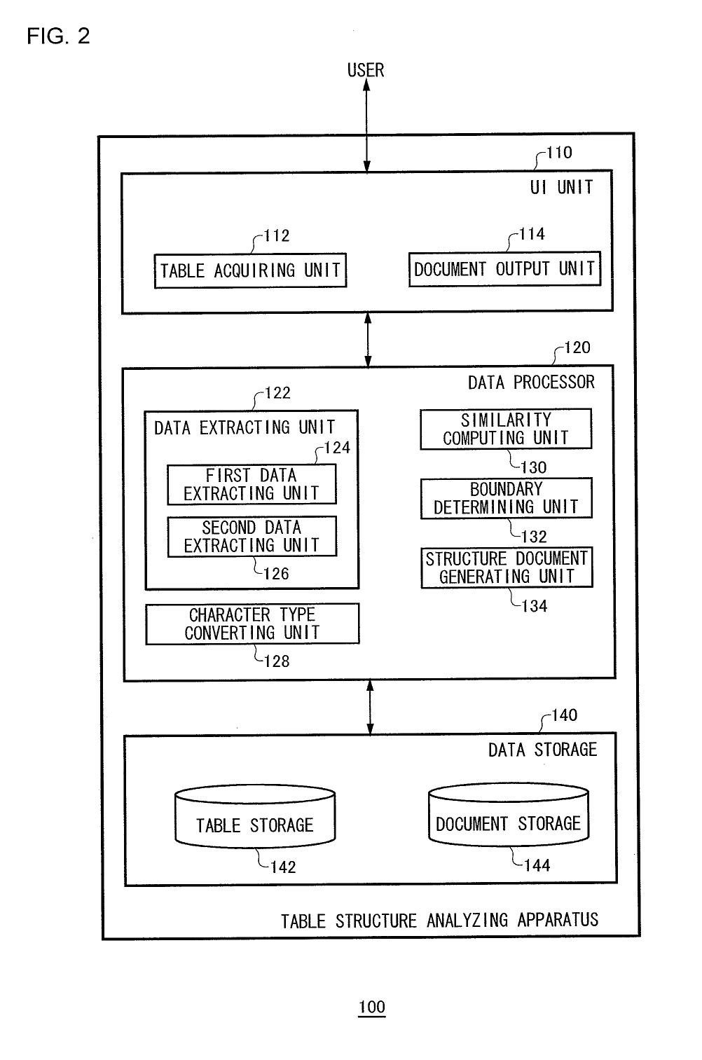

FIG. 2 is a functional block diagram of the table structure analyzing apparatus 100.

The blocks as depicted can be implemented, in hardware, by devices or mechanical units such as a CPU of a computer, and, in software, by, for example, a computer program. FIG. 2 depicts functional blocks implemented by the cooperation of hardware and software. Therefore, it will be obvious to those skilled in the art that the functional blocks may be implemented in a variety of manners by hardware only, software only, or a combination of thereof.

The table structure analyzing apparatus 100 includes a user interface (UI) unit 110, a data processor 120, and a data storage 140.

The UI unit 110 is responsible for processes related to the user interface in general. The data processor 120 performs various data processes based on data acquired from the UI unit 110 or the data storage 140.

The data processor 120 serves the role of an interface between the UI unit 110 and the data storage 140.

The data storage 140 stores various previously prepared configuration data or data received from the data processor 120.

UI Unit 110:

The UI unit 110 includes a table acquiring unit 112 and a document output unit 114. The table acquiring unit 112 acquires table data. Table data may be produced by a spreadsheet application. The table acquiring unit 112 may retrieve table data from a HyperText Markup Language (HTML) document by referring to table tags included in the HTML document. The table data is converted by a structured document generating unit 134 described later into an eXtensible Markup Language (XML) document. Alternatively, the data may be converted into a structured document file of other formats such as an HTML document and an eXtensible HyperText Markup Language (XHTML) document. The document output unit 114 displays the XML document thus generated on a screen. Alternatively, the document is transmitted to an external device.

Data Storage 140:

The data storage 140 includes a table storage 142 and a document storage 144. The table storage 142 stores the table data acquired by the table acquiring unit 112. The document storage 144 stores the XML document generated from the table data.

Data Processor 120:

The data processor 120 includes a data extracting unit 122, a character type converting unit 128, a similarity computing unit 130, a boundary determining unit 132, and a structured document generating unit 134. The data extracting unit 122 retrieves data from table data. The data extracting unit 122 includes a first data extracting unit 124 and a second data extracting unit 126. The first data extracting unit 124 extracts data from the first data series in the table data, and the second data extracting unit 126 extracts data from the second data series adjacent to the first data series. For example, when the first data extracting unit 124 extracts data (1*m) from the first row, the second data extracting unit 126 extracts data (2*m) from the second row. When the first data extracting unit 124 extracts data (n*1) from the first column, the second data extracting unit 126 extracts data (n*2) from the second row.

The character type converting unit 128 converts characters included in the extracted data into predetermined characters (hereinafter, referred to as character type characters) determined by the character type. Conversion into character type characters (hereinafter, simply referred to as “character type conversion”) will be described in detail later.

The similarity computing unit 130 computes the similarity. “Similarity” as used in the embodiment is a concept generic to “data similarity” and “series similarity”. “Data similarity” is a concept generic to “character similarity”, “character type similarity”, and “overall similarity”. The boundary determining unit 132 identifies the boundary between a header part and a substantive part in the table data by referring to the similarity, or, more specifically, the series similarity (hereinafter, such a determination will be referred to as “boundary determination”). A description will now be given of similarity.

(1) Data Similarity

(1-1) Character Similarity

Character similarity denotes similarity between two data items determined on the basis of characters themselves. Character similarity is computed according to the following expression.

$$Sim ( A , B ) = \frac{Max ( A , B ) - Distance ( A , B )}{Max ( A , B )}$$

Sim(A,B): Similarity between character string A and character string B (maximum value: 10)
Max(A,B): The length of the longer of the character strings A and B
Distance(A,B)=Levenshtein distance between character string A and character string B

Levenshtein distance (edit distance) is an indicator used in the field of information theory to indicate how different two character strings are. More specifically, Levenshtein distance indicates the number of steps required to produce the second character string by processing the first character string by inserting, replacing, deleting, or adding characters. The fewer the number of processes required, i.e., the smaller the Levenshtein distance, the first and second character strings are similar.

For example, three steps are required to produce a character string “sitting” by processing a character string “kitten”. In the first step, the first character “k” in “kitten” is replaced by “s” to produce “sitten”. In the second step, the fifth character “e” in “sitten” is replaced by “i” to produce “sittin”. In the third step, the character “g” is added to produce “sitting”. Therefore, the Levenshtein distance between the character strings “kitten” and “sitting” is “3”. Distance(A,B) may not be Levenshtein distance but any appropriate indicator capable of indicating a difference between character strings.

Since the character string “kitten” includes six characters and the character string “sitting” includes seven characters, Max(“kitten”, “sitting”) is “7”. Accordingly, Sim(“kitten”, “sitting”)=(7−3)/7=approximately 0.57. As is evident from the above, given the same Levenshtein distance, the longer the character string, the larger the character similarity. Given the same character string size, the smaller the Levenshtein distance, the larger the character similarity.

The entry “Sales (1*2)” in the first row of FIG. 1A will be similarly compared with “10000 (2*2)” in the second row. “Sales” includes two characters and “10000” includes five characters. Therefore, Max(“Sales”,“100000”)=5. Distance(“Sales”,“10000”)=5. Therefore, Sim(“Sales”,“10000”)=(5−5)/5=0.

“10000 (2*2)” in the second row and “5000 (3*2)” in the third row will be compared. Max(“10000”,“5000”)=5 and Distance(“10000”,“5000”)=2 so that Sim(“10000”,“5000”)=(5−2)/5=0.6.

The first data extracting unit 124 sequentially extracts “Product”, “Sales”, and “Volume sold” from the first row. The second data extracting unit 126 sequentially extracts “Taro”, “10000”, and “250” from the second row. The similarity computing unit 130 computes the character similarity between “Product” and “Taro”, “Sales” and “10000”, and “Volume sold” and “250”, respectively.

(1-2) Character Type Similarity

Character type similarity denotes similarity between two data items subject to comparison based on the character type. The expression for computing the character type similarity is identical to the expression for computing the character similarity. Before computing the character type similarity, however, the characters included in the character strings subject to comparison are converted as follows.

| | |
|---|---|
| Numerals, symbols | −> 0 |
| Alphabets | −> A |
| Full-width characters | −> ZZ |
| Half-width katakana characters | −> Y |
| Full-width delimiters | −> // |
| Other characters | −> * |

“0”, “A”, “ZZ”, “Y”, “//”, and “*” are character type characters.

For example, the character string “kitten” is converted into “AAAAAA” by character type conversion, and the character string “sitting” is converted into “AAAAAAA” by character type conversion. The Levenshtein distance between the character string “kitten” after character type conversion and the character string “sitting” after character type conversion is the Levenshtein distance between the character string “AAAAAA” and the character string “AAAAAAA”, i.e., “1”. Accordingly, the character type similarity Sim(“kitten”, “sitting”)=(7−1)/7=approximately 0.86. The longer the character string subject to comparison, the larger the character type similarity. The smaller the Levenshtein distance, the larger the character type similarity. The impact due to the difference in character type on the character type similarity is larger than the impact on the character similarity.

The character type similarity between “Sales (1*2)” in the first row in FIG. 1A and “10000 (2*2)” in the second row will be determined. Since “Sales”->“ZZZZ” and “10000”->“00000”, Distance(“Sales”,“10000”)=5 so that the character type similarity Sim(“Sales”,“100000”)=(5−5)/5=0.

“10000 (2*2)” in the second row and “5000 (3*2)” in the third row will be compared. Since “10000”->“00000” and “5000”->“0000”, Distance(“10000”,“5000”)=1 so that the character type similarity Sim(“10000”,“5000”)=(5−1)/5=0.8.

The character type converting unit 128 converts the character type of the data extracted by the first data extracting unit 124 and the second data extracting unit 126. The similarity computing unit 130 computes the character type similarity between the character strings after character type conversion.

(1-3) Overall Similarity

Overall similarity is similarity based on character similarity and character type similarity.

Overall similarity is computed according to the following expression.

Overall similarity Sim3(A,B)=a×Character similarity Sim1(A,B)+b×Character type similarity Sim2(A,B) a, b: constants

Given that the first data extracting unit 124 extracts data from the first row and the second data extracting unit 126 extracts data from the second row, the similarity computing unit 130 computes the character similarity, character type similarity, and overall similarity for the combinations “Product” and “Taro”, “Sales” and “10000”, and “Volume sold” and “250”. In this embodiment, the expression for computing overall similarity is set up such that a=0.3 and b=0.7 so that the impact of character type similarity is larger than that of character similarity.

(2) Series Similarity

Series similarity is similarity between two data series subject to comparison. The similarity computing unit 130 computes the series similarity based on the data similarity, i.e., based on the character similarity, character type similarity, or overall similarity. In this embodiment, the series similarity is computed based on the overall similarity. More specifically, the similarity computing unit 130 determines an average of the overall similarity as the series similarity.

For example, given, as a result of comparing the first row and the second row, that the overall similarity between “Product” and “Taro” is denoted by A1, the overall similarity between “Sales” and “10000” is denoted by A2, and the overall similarity between “Volume sold” and “250” is denoted by A3, the average of A1-A3 represents the series similarity between the first row and the second row. If the series similarity is equal to or smaller than a predetermined threshold value (hereinafter, referred to as “boundary threshold value”) (e.g., equal to or smaller than 0.32), it is determined that the boundary between the first row and the second row is the boundary between the header part and the substantive part.

In comparison, the header data and the substantive data in table data usually present a significant difference in data type and size. The table structure analyzing apparatus 100 implements boundary determination using an algorithm that reflects the above finding. Our experiments using the parameters a=0.3, b=0.7, and boundary threshold value=0.32 produced boundary determination with the accuracy of approximately 90%.

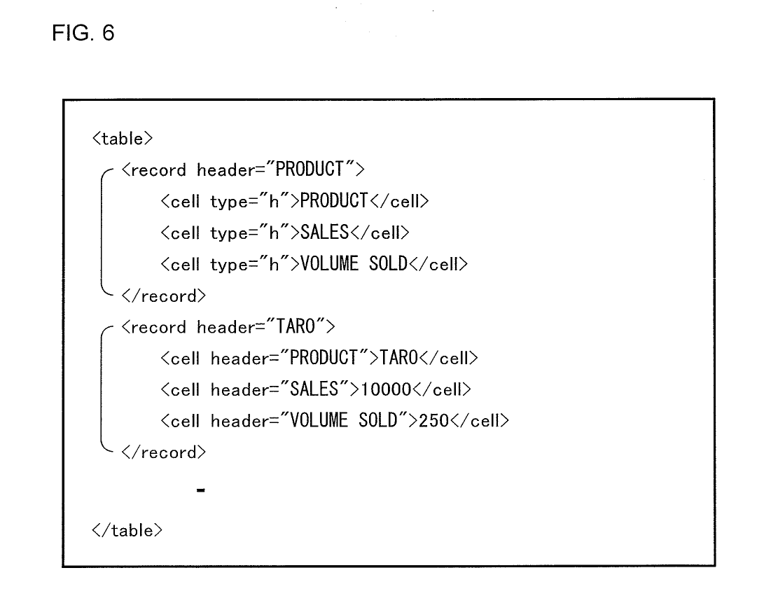

Instead of a simple average of A1-A3, a weighted average may be used to obtain the series similarity. The structured document generating unit 134 structures the table data according to the result of boundary determination and produces an XML document accordingly. Generation of an XML document will be described in detail with reference to FIG. 6 and the subsequent drawings.

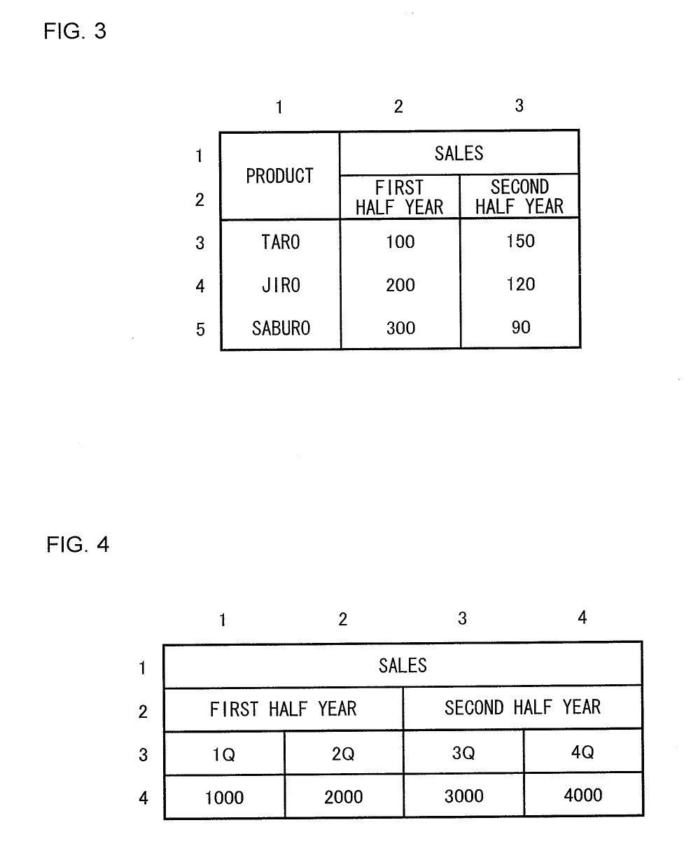

FIG. 3 shows exemplary table data where some of the cells are merged.

In the table data of 5 rows×3 columns shown in FIG. 3, the first and second rows share “Product (1*1) (2*1)”. In the case of the table data with such a structure, the boundary between the first and second rows does not normally represent the boundary between the header part and the substantive part. Thus, when the data series subject to comparison share at least one data item, the boundary determining unit 132 determines that a boundary is not identified without computing the series similarity. Instead, the boundary determining unit 132 performs a boundary determination on the second and third rows.

Hereinafter, a table structure as that of FIG. 3 where data is shared by the data series subject to comparison will be referred to as a “first pattern structure”.

FIG. 4 shows another exemplary table data where some of the cells are merged.

In the table data of 4 rows×4 columns shown in FIG. 4, the first row contains only one data item but the second row contains two data items. In other words, two entries “First half year (2*1-2)” and “Second half year (2*3-4)” are associated with “Sales (1*1-4)”. In the table data with such a structure, it is unlikely that the boundary between the first and second rows represents the boundary between the header part and the substantive part. Therefore, the first and second rows are compared such that the overall similarity scores A1 and A2 are computed for the pair “Sales” and “First half year” and the pair “Sales” and “Second half year”. Further, the similarity computing unit 130 adds a predetermined calibration value (e.g., 0.07) to the overall similarity scores A1 and A2. The calibration ensures that the boundary between the first and second rows in the table data shown in FIG. 4 will be less likely to be determined to be the boundary between the header part and the substantive part. If the boundary between the first and second rows is not determined to be the boundary between the header part and the substantive part, the boundary determining part 132 performs a boundary determination on the second and third rows.

Hereinafter, a table structure as that of FIG. 4 where data in the data series subject to comparison exhibit one-to-many correspondence will be referred to as a “second pattern structure”.

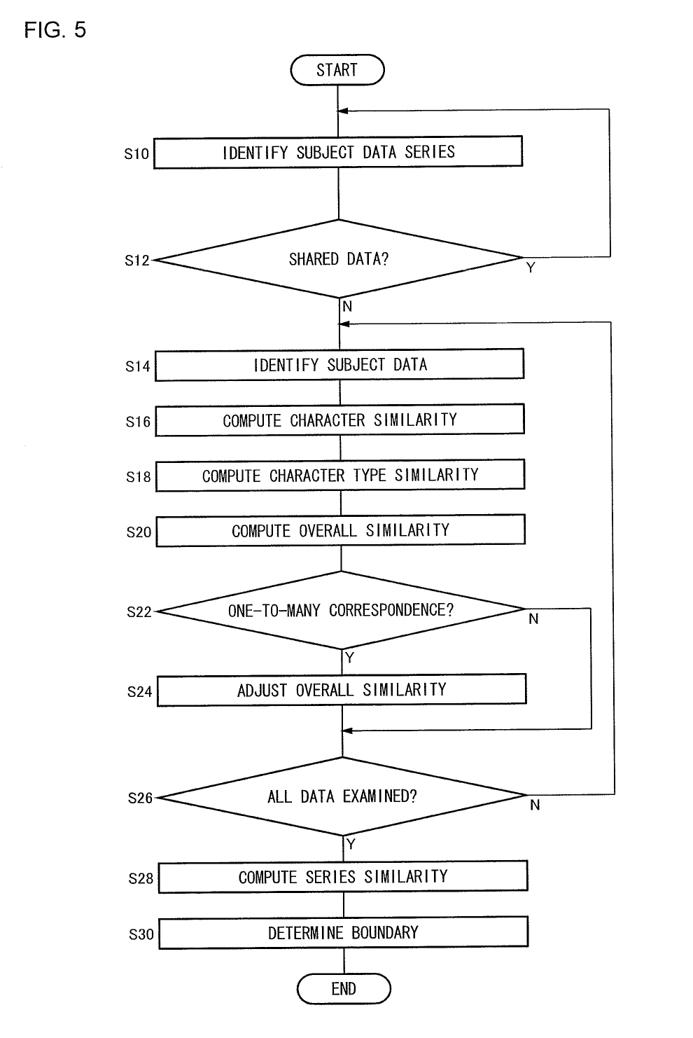

FIG. 5 is a flowchart of steps for determining a boundary.

First, the data extracting unit 122 identifies data series subject to comparison (S10). For example, the first and second rows are identified. If the first and second rows share one data item (Y in S12), or, in other words, if the table data has the first pattern structure, another data series is selected as a target of comparison. If the table data has the first pattern structure in relation to the first and second rows, the second and third rows are subject to comparison. If the table data does not have the first pattern structure (N in S12), the first data extracting unit 124 and the second data extracting unit 126 sequentially extract data subject to comparison (S14). In the case of the table data of FIG. 1A, the first and second rows are subject to comparison. First, the first data extracting unit 124 extracts “Product (1*1)” and the second extracting unit 126 extracts “Taro (2*1)”. The similarity computing unit 130 computes the character similarity Sim1 (S16). In the case of “Product (1*1)” and “Taro (2*1)”, the character similarity Sim1 will be “0”.

Subsequently, the character type converting unit 128 converts the character type of the data subject to comparison and the similarity computing unit 130 computes the character type similarity Sim2 (S18). In the case of “Product (1*1)” and “Taro (2*1)”, the character type is converted such that “Product (1*1)”->“ZZZZ” and “Taro (2*1)”->“ZZZZ” so that the character type similarity Sim2 is “1”.

The similarity computing unit 130 then computes the overall similarity Sim3 (S20). In the case of “Product (1*1)” and “Taro (2*1)”, Sim3=0.3×Sim1+0.7×Sim2=0.7.

If the data subject to comparison exhibit one-to-many correspondence as in the case of the second pattern (Y in S22), or, in other words, if the table data has the second pattern structure, the overall similarity is adjusted by adding a calibration value (S24). If the data do not exhibit one-to-many correspondence (N in S22), S24 is skipped. If there is unexamined data in the data series subject to comparison (N in S26), the process is returned to S14. In the case of the table data of FIG. 1A, “Sales (1*2)” and “10000 (2*2)” are selected as next targets of comparison and the overall similarity between “Sales (1*2)” and “10000 (2*2)” is computed. In the case of the first and second rows of the table data of FIG. 1A,
Sim3(“Product”, “Taro”)=0.7
Sim3(“Sales”,“10000”)=0
Sim3 (“Volume sold”, “250”)=0

When the overall similarity has been computed for all data (Y in S26), the similarity computing unit 130 computes the series similarity Sim4 by computing the average of the overall similarity scores Sim3. In the above example, Sim4=(0.7+0+0)/3=0.23. The boundary determining unit 132 performs a boundary determination by examining whether the series similarity is equal to 0.32 or below (S30). In the above example, the series similarity Sim4 between the first and second rows is below the boundary threshold value 0.32 so that the boundary between the first and second rows is determined to be the boundary between the header part and the substantive part.

Similarly, the similarity is computed for the columns and a boundary determination is made to examine whether a header column is found. In this way, the header part and the substantive part of the table data are automatically identified. The structured document generating unit 134 structures the data included in the table data by referring to the result of boundary determination and generates an XML document accordingly.

FIG. 6 shows an XML document based on the table data of FIG. 1A.

The table itself is indicated by a table tag. A record tag indicates a row. Since the table data of FIG. 1A contains four rows, there are four record elements.

A header attribute of a record tag indicates the row header of the row. If there are no row headers, i.e., if there are no header columns, a header attribute is not provided. For example, in the case of the table data of FIG. 1A, the row headers of the rows are “Product”, “Taro”, “Jiro”, and “Saburo”. Therefore, the header attributes of the record tags corresponding to the respective rows are “Product”, “Taro”, “Jiro”, and “Saburo”, respectively.

A cell element indicates data included in the row. Since there are three columns, the number of cell elements in each record element is three.

A header attribute of a cell tag indicates the column header of the data. If there are no column headers, i.e., if there are no header rows, a header attribute is not provided. If the data itself is a column header, a type attribute “h” is provided in the cell tag. In the case of the table data of FIG. 1A, the column headers of the columns are “Product”, “Sales”, and “Volume sold”. Therefore, the header attributes of the cell tags are “Product”, “Sales”, and “Volume sold”, respectively. Since the data included in the first row are column headers, the type attribute “h” is provided instead of the header attribute.

Structuring the data in an XML document allows data search using XPath. For example, a search expression

//record[@header=“Taro”]
is used to retrieve data on a row having a row header name=“Taro”.

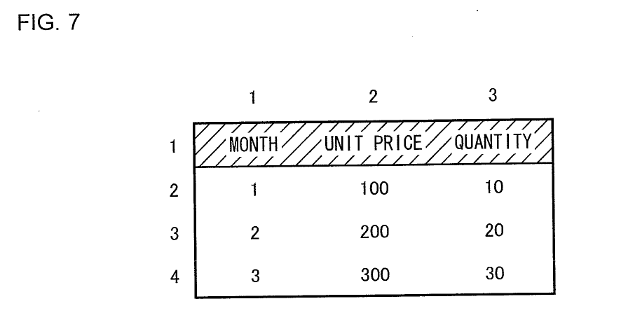

FIG. 7 shows table data where only the first row forms a header part.

The table data shown in FIG. 7 include a total of 12 data items organized as 4 rows×3 columns. The first row is a header row and the second through fourth rows are substantive rows. The first through third columns are all substantive columns.

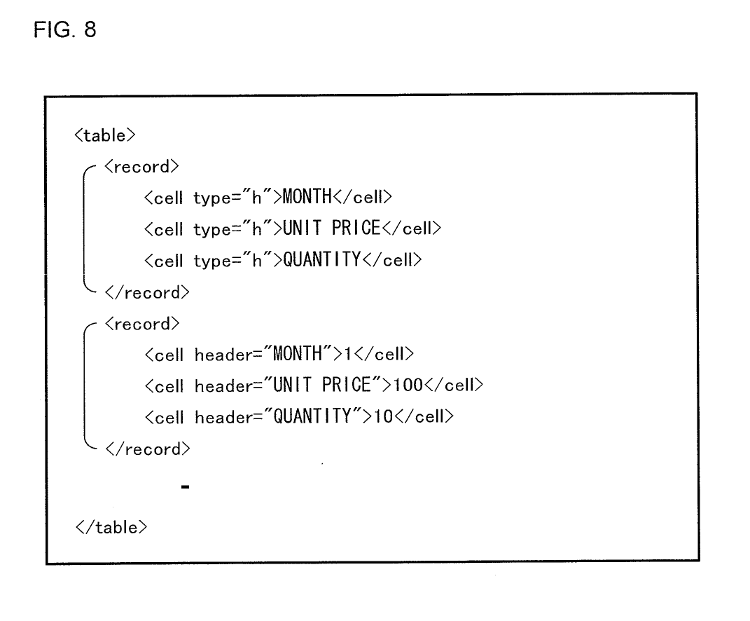

FIG. 8 shows an XML document based on the table data of FIG. 7.

Since there are four rows in the table data of FIG. 7, there are four record elements.

Since there are no header columns, i.e., since there are no row headers, each record tag is not provided with a header attribute. Since there are three columns, the number of cell elements in each record element is three.

In the case of the table data of FIG. 7, the column headers of the respective columns are “Month”, “Unit price”, and “Quantity”. Since the first row is a header row, a type attribute “h” is provided in the cell element. Each of the cell elements in the second through fourth rows is provided with a header=column header.

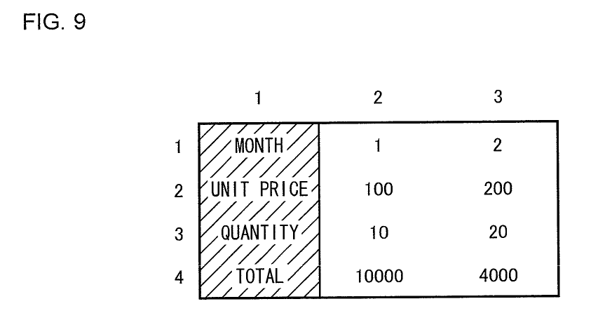

FIG. 9 shows table data where only the first column forms a header part.

The table data shown in FIG. 9 include a total of 12 data items organized as 4 rows×3 columns. The first row is a header row and the second and third rows are substantive rows. The first through fourth columns are all substantive columns.

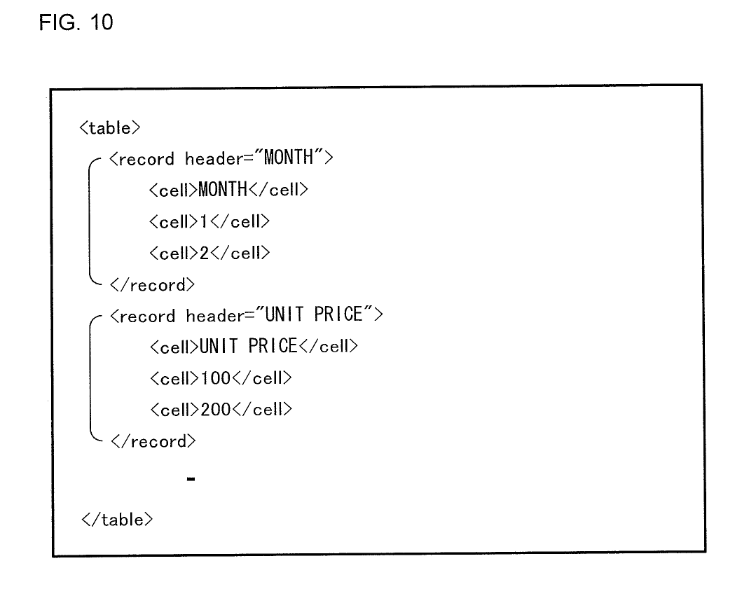

FIG. 10 shows an XML document based on the table data of FIG. 9.

Since there are four rows in the table data of FIG. 9, there are four record elements. Since the first column is a header column, a row header is provided in the header attribute of each record tag. Since there are three columns, the number of cell elements in each record element is three. Since there are no header rows, i.e., since there are no column headers, each cell tag is not provided with a header attribute or a type attribute.

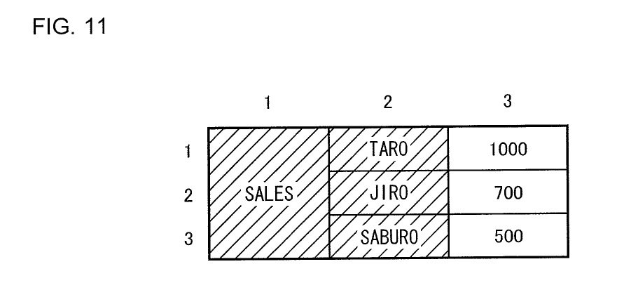

FIG. 11 shows table data where the first and second columns form header parts.

The table data shown in FIG. 11 includes three rows×three columns. Since the first column includes only one data item, a total of seven data items are included. The first and second columns are header columns, and the third column is a substantive column. The first through third rows are all substantive rows. The data in the first column “sales” and the data in the second columns “Taro”, “Jiro”, and “Saburo” are in one-to-three relationship. Therefore, the second pattern structure is formed.

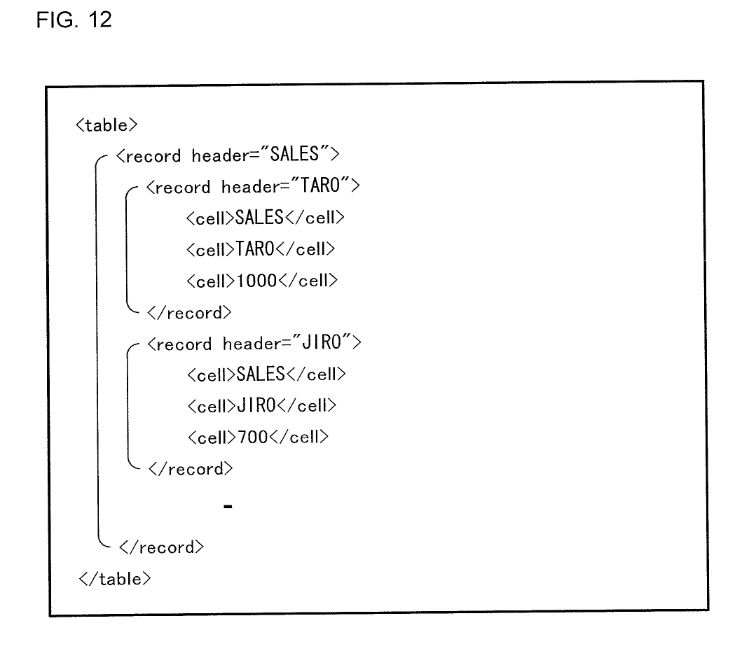

FIG. 12 shows an XML document based on the table data of FIG. 11.

The table data of FIG. 11 is structured such that the three rows “Taro”, “Jiro”, and “Saburo” are included in the “Sales” row. Thus, FIG. 12 shows a tag structure where the record element corresponding to the “Taro” row, the record element corresponding to the “Jiro” row, and the record element corresponding to the “Saburo” row are included in the record element corresponding to the “Sales” row.

The row header “Sales” is provided in the header attribute of the record element corresponding to the “Sales” row. The row headers “Taro”, “Jiro”, and “Saburo” are provided in the header attributes of the record elements corresponding to the “Taro” row, “Jiro” row, and “Saburo” row, respectively. Since there are no column headers, neither a type attribute nor a header attribute is provided in the cell elements.

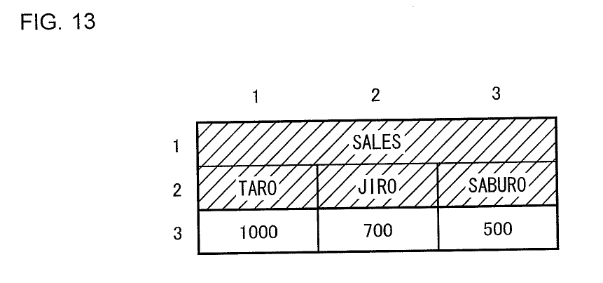

FIG. 13 shows table data where the first and second rows form header parts.

The table data shown in FIG. 13 includes three rows×three columns. Since the first row includes only one data item, a total of seven data items are included. The first and second rows are header rows, and the third row is a substantive row. The first through third columns are all substantive columns. The data in the first row “sales” and the data in the second row “Taro”, “Jiro”, and “Saburo” are in one-to-three relationship. Therefore, the second pattern structure is formed.

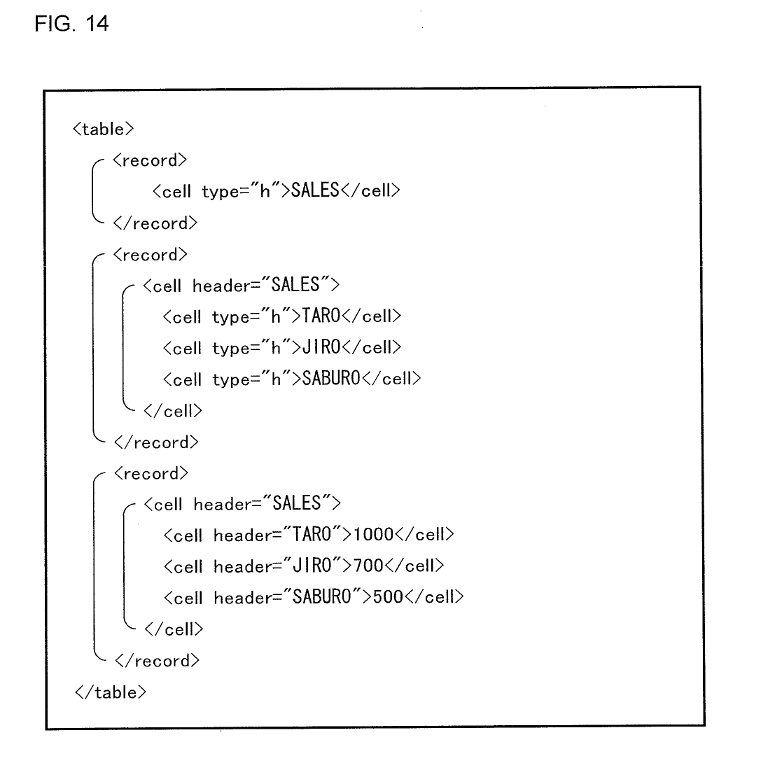

FIG. 14 shows an XML document based on the table data of FIG. 13.

Since the three rows are independent of each other in the table data shown in FIG. 13, there are three record elements. Since there are no row headers, each record element is not provided with a header attribute. Since the first row includes only the header data “Sales”, the record element corresponding to the first row includes only one cell element. Since the first row is a header row, a type attribute “h” is provided.

Since the second row includes three data items “Taro”, “Jiro”, and “Saburo”, there are three cell elements. Since the second row is also a header row, a type attribute “h” is provided. Since the header data items in the second row belong to the header data “Sales” in the first row, “Sales” is provided as the header attribute of the cell element encompassing the three cell elements.

Since the third row includes three data items “1000”, “700”, and “500”, there are three cell elements. Since the third row is a substantive row, no type attributes are provided. The data items in the third row belong to the header data items “Taro”, “Jiro”, and “Saburo” in the second row, respectively, and further belong to the header data “Sales” in the first row.

Described above is the table structure analyzing apparatus 100.

When table data comprising a plurality of data items is acquired by the table structure analyzing apparatus 100, the header part and the substantive part of the table data are identified automatically and with a high precision. Normally, the character type in the header part in table data often differs from that of the substantive part. Thus, the precision of identifying a boundary is more likely to be improved by performing a boundary determination based on the character type similarity or overall similarity instead of the character similarity. The precision is further improved by weighting the character type similarity more than the character similarity in computing the overall similarity.

The precision in boundary determination is further improved by allowing for the structural features such as the first pattern structure and the second pattern structure described in the embodiment. By creating an XML document based on the table structure identified as a result of boundary determination, the table data can be handled more easily, using the general-purpose technology such as XPath.

### Second Embodiment

In the first embodiment, a description is given of the example where the table structure analyzing apparatus 100 automatically identifies a header part and a substantive part of a table. In the second embodiment, a description is given of the example where the table structure analyzing apparatus 100 acknowledges the designation of header data of a table from a user.

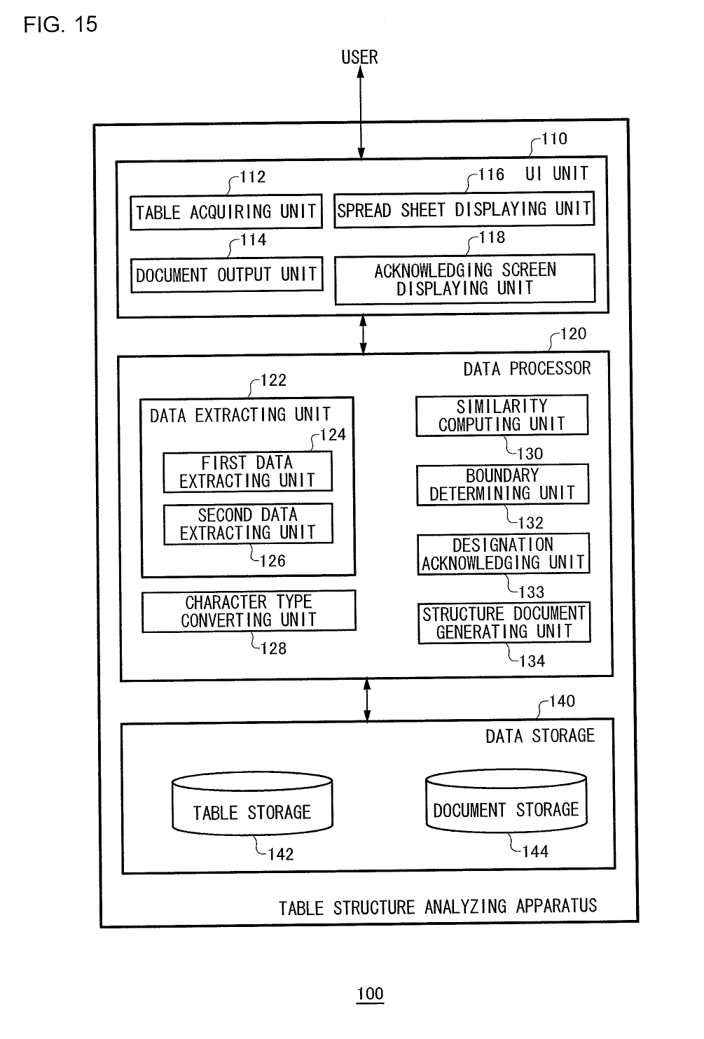

FIG. 15 is a functional block diagram of the table structure analyzing apparatus 100 according to the second embodiment. In addition to the components of the table structure analyzing apparatus 100 according to the first embodiment shown in FIG. 2, the table structure analyzing apparatus 100 according to the second embodiment is further provided with a spread sheet displaying unit 116, an acknowledging screen displaying unit 118, and a designation acknowledging unit 133.

The designation acknowledging unit 133 acknowledges from the user the designation of the range of a table as a whole in the table data acquired by the table acquiring unit 112 and stored in the table storage 142, the designation of a boundary between a header part and a substantive part, etc. The designation acknowledging unit 133 causes the acknowledging screen displaying unit 118 to display an acknowledging screen that serves as a user interface for acknowledging information related to the table structure from the user. The unit 133 acknowledges the designation from the user via the acknowledging screen. The spread sheet displaying 116 displays the table stored in the table storage 142 in the spread sheet format, as a user interface for acknowledging the range of the table as a whole, the range of header row, the range of header column, etc. The designation acknowledging unit 133 acknowledges from the user the designation of ranges in the form of a mouser drag operation, etc. in the spread sheet screen displayed by the spread sheet displaying unit 116.

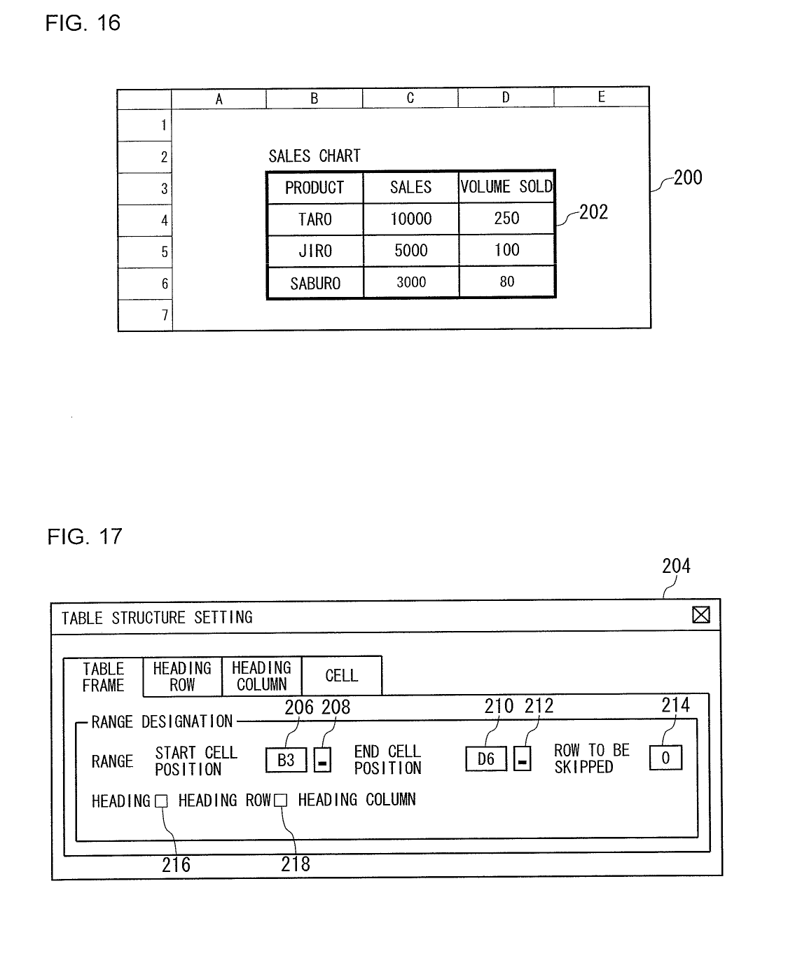

FIG. 16 shows an example of a screen displaying the table data shown in FIG. 1A in the spread sheet format. A screen 200 shows table data 202 acquired by the table acquiring unit 112 and stored in the table storage 142.

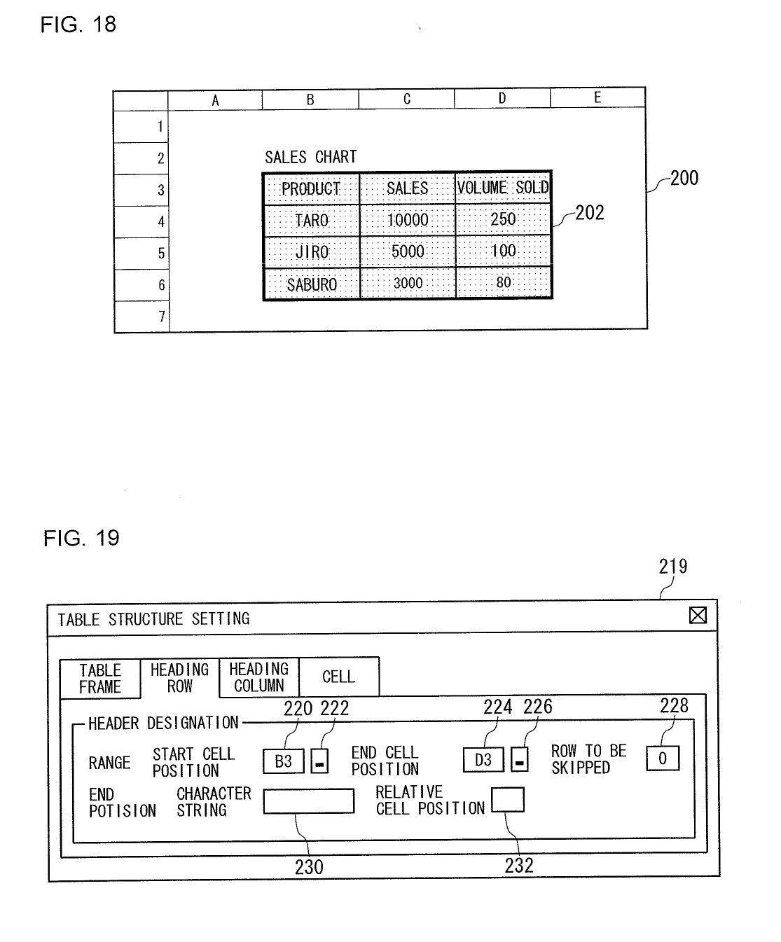

FIG. 17 shows an example of a user interface screen for acknowledging information related to the table structure from the user. The setting of the range of the table as a whole and the setting of a header row or a header column (heading), if any, are acknowledged from the user in a user interface screen 204 shown in FIG. 17. The user can designate the range of the table as a whole by entering the cell position where the table starts in a text box 206 for entering the start position and by entering the cell position where the table ends in a text box 210 for entering the end position. The user can also designate the range of the table as a whole by clicking a button 208 or a button 212 and by, for example, dragging the mouse from the start cell position to the end cell position in the screen 200 displaying the table data in the spread sheet format, as shown in FIG. 18. In the case where a plurality of rows appear as a single row by merging cells or in the case where the table data is presented such that regular intervals are provided between rows, the user can designate that rows of the table occur at intervals designated by entering the number of rows to be skipped in a text box 214 for entering the number of rows to be skipped.

If there is a header row in the table data, the header row can be designated by checking a check box 216 for designating that there is a header row (heading row). In this case, the designation acknowledging unit 133 sets, as the header row, the row that includes the start cell position in the range of table data designated, i.e., the first row located at the topmost position. Similarly, if there is a header column in the table data, the header column can be designated by checking a check box 218 for designating that there is a header column (heading column). In this case, the designation acknowledging unit 133 sets, as the header column, the column that includes the start cell position in the range of table data designated, i.e., the first column located at the leftmost position.

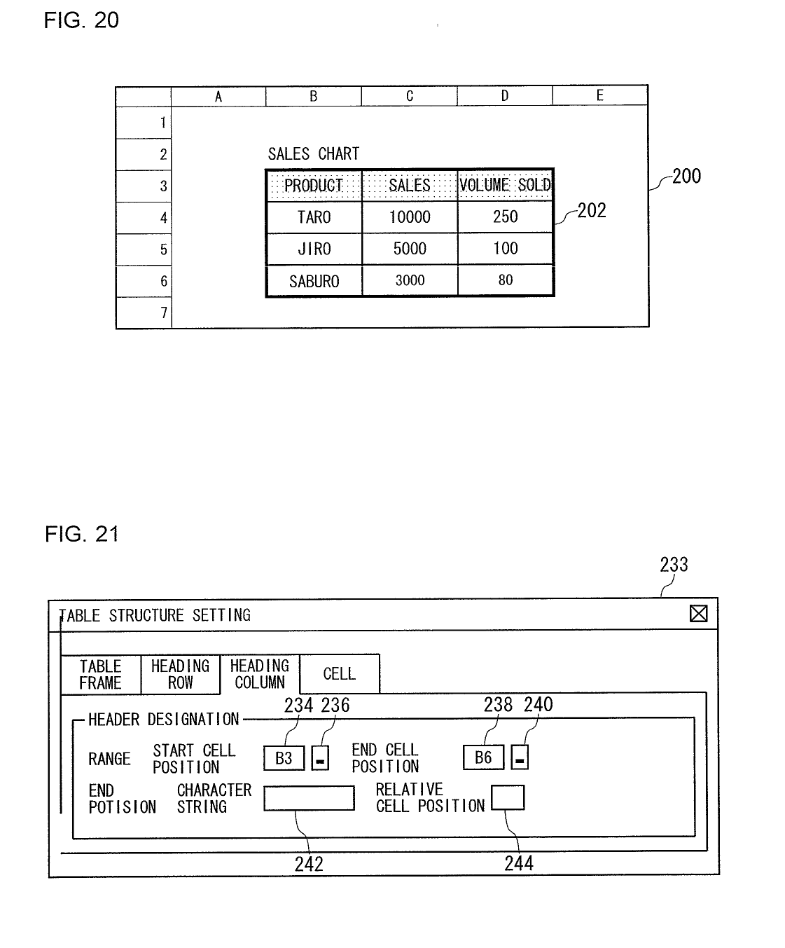

FIG. 19 shows an example of a user interface screen for acknowledging information related to the table structure from the user. The setting of the range of a header row (heading row) and the setting of the position where the table ends are acknowledged in a user interface screen 219 shown in FIG. 19. The user can designate the range of a header row by directly entering the cell position where the header row starts in a text box 220 for entering the header row start position, and entering the cell position where the header row ends in a text box 224 for entering the header row end position. The user can also designate the range of the header row by clicking a button 222 or a button 226 and dragging the mouse from the start cell position to the end cell position in the screen 200 displaying the table data in the spread sheet format, as shown in FIG. 20. In the case where a plurality of rows appear as a single row by merging cells or in the case where the table data is presented such that regular intervals are provided between rows, the user can designate that rows of the table occur at intervals designated by entering the number of rows to be skipped in a text box 228 for entering the number of rows to be skipped.

When the range of the header row is designated, the designation acknowledging unit 133 sets the start cell position of the header row as the start cell position of the table as a whole. Absent the designation of the end position of the table, the designation acknowledging unit 133 searches the table downward, starting at the header row, and sets the row immediately preceding the first blank row as the end of the table data. The user may designate, as the table end, a cell position relative to a cell position where a specific character string occurs. For example, the user may designate, as the end cell position, the cell (D, 6) occurring at a position (+2, +4) with reference to the cell (B, 2) where the character string “Sales chart” occurs, by entering “Sales chart” in a text box 230 for entering a character string and entering “(+2, +4)” in a text box 232 for entering the relative cell position.

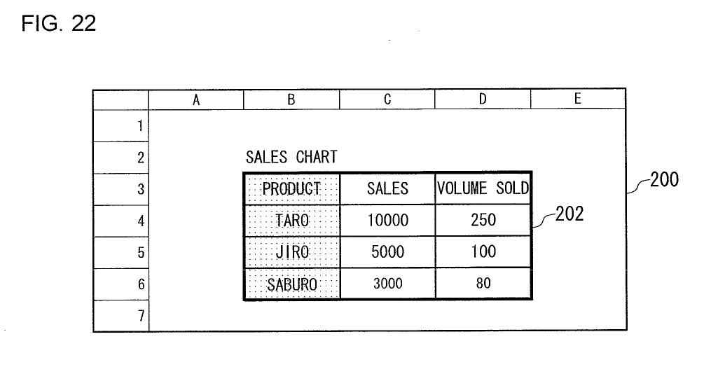

FIG. 21 shows an example of a user interface screen for acknowledging information related to the table structure from the user. The setting of the range of a header column (heading column) and the setting of the position where the table ends are acknowledged in a user interface screen 233 shown in FIG. 21. The user can also designate the range of a header column by directly entering the cell position where the header column starts in a text box 234 for entering the header column start position, and entering the cell position where the header column ends in a text box 238 for entering the header column end position. The user can also designate the range of the header column by clicking a button 236 or a button 240 and dragging the mouse from the start cell position to the end cell position in the screen 200 displaying the table data in the spread sheet format, as shown in FIG. 22,

When the range of the header column is designated, the designation acknowledging unit 133 sets the start cell position of the header column as the start cell position of the table as a whole. Absent the designation of the end position of the table, the designation acknowledging unit 133 searches the table rightward, starting at the header column, and sets the column immediately preceding the first blank column as the end of the table data. The user may designate, as the table end, a cell position relative to a cell position where a specific character string occurs. For example, the user may designate, as the end cell position, the cell (D, 6) occurring at a position (+2, +4) with reference to the cell (B, 2) where the character string “Sales chart” occurs, by entering “Sales chart” in a text box 242 for entering a character string and entering “(+2, +4)” in a text box 244 for entering the relative cell position.

When the designation acknowledging unit 133 has acknowledged information related to the table structure from the user, the structured document generating unit 134 can generate a structured document based on the acknowledged information.

When the boundary determining unit 132 is not capable of identifying a boundary, the table structure analyzing apparatus 100 may acknowledge the designation using the designation acknowledging unit 133. Information obtained by automatic determination by the boundary determining unit 132 may be entered as default values in the acknowledging screen, when the designation acknowledging unit 133 acknowledges the designation from the user. In this way, user convenience is improved.

Described above is an explanation based on an exemplary embodiment. The embodiment is intended to be illustrative only and it will be obvious to those skilled in the art that various modifications to constituting elements and processes could be developed and that such modifications are also within the scope of the present invention.

What is claimed is:

1. A table structure analyzing apparatus comprising:
a table acquiring unit operative to acquire table data;
a first data extracting unit operative to extract first data from a first data series in the table data;
a second data extracting unit operative to extract second data from a second data series adjacent to the first data series;
a similarity computing unit operative to compute similarity between the first data and the second data; and
a boundary determining unit operative to determine that a boundary between the first data series and the second data series represents the boundary between a header part and a substantive part of the table data, if the similarity is smaller than a predetermined threshold value, wherein the fewer the number of processes required to produce the second data by processing the first data, the higher the similarity as computed by the similarity computing unit.

2. The table structure analyzing apparatus according to claim 1, wherein
the smaller the Levenshtein distance between the first data and the second data, the higher the similarity as computed by the similarity computing unit.

3. The table structure analyzing apparatus according to claim 1, wherein
the larger the number of characters in the first data or the number of characters in the second data, the higher the similarity as computed by the similarity computing unit.

4. The table structure analyzing apparatus according to claim 1, further comprising:
a character type converting unit operative to convert characters included in the data into character type characters indicating the character type;
the similarity computing unit computes the similarity between the first data after conversion and the second data after conversion.

5. The table structure analyzing apparatus according to claim 4, wherein
the similarity computing unit computes similarity between the first data before conversion and the second data before conversion as character similarity, computes similarity between the first data after conversion and the second after conversion as character type similarity, and computes a sum of the character similarity and the character type similarity as similarity for determining the boundary.

6. The table structure analyzing apparatus according to claim 5, wherein
the similarity computing unit weights one or both of the character similarity and the character type similarity before adding the character similarity and the character type similarity.

7. The table structure analyzing apparatus according to claim 6, wherein
the similarity computing unit assigns a weight so that the impact of the character type similarity is larger than that of the character similarity.

8. The table structure analyzing apparatus according to claim 1, wherein
the similarity computing unit computes similarity in a plurality of sets each comprising the first data in the first data series and the second data in the second data series corresponding to each other, outputting the similarity thus computed as data similarity, and computes similarity between the first data series and the second data series based on the data similarity in the plurality of sets, and
if the series similarity is smaller than a predetermined threshold value, the boundary determining unit determines that the boundary between the first data series and the second data series as the boundary between the header part and the substantive part.

9. The table analyzing apparatus according to claim 1, wherein
the boundary determining unit determines that the boundary between the first data series and the second data series is not a boundary between the header part and the substantive part, if the first data series and the second data series share data.

10. The table structure analyzing apparatus according to claim 1, wherein
when a single data item in the first data series is associated with a plurality of data items in the second data series, the similarity computing unit increases the similarity.

11. The table structure analyzing apparatus according to claim 1, further comprising:
a structured document generating unit operative to generate a structured document reflecting the structure of the table data by assigning attribute information signifying a header to the data included in the first data series and assigning attribute information signifying a content to the data included in the second data series, when the first data series represents the header part and the second data series the substantive part.

12. The table structure analyzing apparatus according to claim 1, further comprising:
a designation acknowledging unit operative to acknowledge the designation of the header part and the substantive part from a user.

13. A table structure analyzing method comprising: acquiring table data:
extracting first data from a first data series in the table data;
extracting second data from a second data series adjacent to the first data series;
computing similarity between the first data and the second data; and
determining that a boundary between the first data series and the second data series represents the boundary between a header part and a substantive part of the table data, if the similarity is smaller than a predetermined threshold value, wherein
the fewer the number of processes required to produce the second data by processing the first data, the higher the similarity as computed.

14. A table structure analyzing program product adapted for computer-implemented processes of:
acquiring table data:
extracting first data from a first data series in the table data;
extracting second data from a second data series adjacent to the first data series;
computing similarity between the first data and the second data; and
determining that a boundary between the first data series and the second data series represents the boundary between a header part and a substantive part of the table data, if the similarity is smaller than a predetermined threshold value, wherein
the fewer the number of processes required to produce the second data by processing the first data, the higher the similarity as computed.
